(19) United States
(12) Patent Application Publication
(10) Pub. No.: US 2005/0234864 A1
(43) Pub. Date: Oct. 20, 2005

(54) Systems and methods for improved data sharing and content transformation

(76) Inventor: Aaron M. Shapiro, Atlanta, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/110,036

(22) Filed: Apr. 20, 2005

Related U.S. Application Data
(60) Provisional application No. 60/563,471, filed on Apr. 20, 2004.

(51) Int. Cl. G06F 7/00

(52) U.S. Cl. 707/1

(57) ABSTRACT

A user's personal computer can be turned into a personal network server for easily sharing personal digital information with other people using a wide variety of devices. There are a variety of alternative ways in which such file sharing on the user's computer can be implemented, such as with a client-side server approach, a hosted server approach, and an automated publish approach. Depending upon a variety of factors, the requested shared data may be intelligently and dynamically transformed to better fit the requesting party's needs. Programming interfaces are available to third parties that allow for access to the shared data and for providing customized instructions on what to do when transforming the data.

### FIELD OF THE INVENTION

This invention relates to systems for sharing and transforming data into alternative formats and, more particularly, to systems and methods that facilitate easy sharing of personal digital information while dynamically transforming the personal digital information based upon a desired data format associated with a requested party.

### RELATED APPLICATIONS

This patent application claims priority to an earlier filed provisional patent application filed Apr. 20, 2004 and entitled “Systems and Method for Improved Data Sharing and Content Transformation” by Aaron M. Shapiro. The content of this provisional patent application is hereby incorporated by reference in its entirety.

### BACKGROUND OF THE INVENTION

The proliferation of personal computers into our lives has created a wealth of personal digital information (more generally referred to as data) related to computer users. Personal digital information generally includes any type of data created by the user, such as a digital photographs or images, electronic calendar information, contact files, word processing files, video images, sound files, etc. This data can include information automatically created by software programs, or documents developed for business use.

Traditionally, this type of data is stored on the hard drive of the user's personal computer. For example, the user may take digital photographs of a vacation and store them onto the hard drive of their personal computer before uploading the photographs to an online digital photo service. The user may also keep an electronic calendar for appointments, anniversaries, and birthdays on the hard drive as part of their personal information management software applications (such as the Lotus ORGANIZER application or the Microsoft OUTLOOK application). Further, contact information on the user's acquaintances may be stored electronically in the hard drive for use with a personal organizer program, such as Lotus ORGANIZER or Microsoft OUTLOOK. While it is typically easy for the user to access such personal digital information, there are obstacles when attempting to seamlessly and easily share the user's own personal digital information with others. Obstacles also exist when attempting to access this information remotely, either from a different computer or from an Internet-connected device, such as a network-enabled personal data organizer (PDA or PocketPC) or cell phone.

A known way to share such personal digital information is using a “centralized server” approach whereby the personal digital information is uploaded to the centralized server, which can then be accessed by third parties or by the individual when away from their computer. In more detail, the user uploads files they want to share to the centralized server. This is similar to uploading selected image files from the user's hard drive or the user's digital camera to a website (e.g., www.ofoto.com or www.shufterfly.com) via an Internet connection. Once the files have been uploaded, third parties may have access to these shared files by requesting a file from the centralized server. In response, the centralized server provides the requested one of the uploaded files in a similar way as digital photographs may be shared with third parties after having been uploaded to the above-referenced online photo services at www.ofoto.com and www.shutterfly.com.

Another centralized server example for remote sharing files is available from a company called Mirra, Inc. (formerly known as Ispiri, Inc.). Mirra provides a hardware solution called the Mirra Personal Server (http://www.mirra.com/product/) that is connected to the user's personal computer and home network. The Mirra Personal Server operates separately from the user's personal computer to provide secure remote access to files copied from the user's own personal computer and kept on a Mirra corporate web server. This allows others to share such files.

While these products and online services provide a level of shared access for particular files, there are a host of undesirable problems incurred when using a centralized server approach for sharing files. For example, the time to upload the user's personal digital information from the user's own personal computer to the networked centralized server may be significant and burdensome for large files and large quantities of files. While this will depend on the capacity of the connection to the networked centralized server, it nonetheless can pose a significant performance impediment. Further, files not selected in advance by the user are not automatically uploaded to the centralized server and made available for sharing. Instead, the user must constantly and manually update what has been uploaded onto the centralized server. Furthermore, once the files are uploaded, changes to the original file resident back in the hard drive of the user's personal computer will not be reflected in the uploaded files, thus causing frustrating synchronization issues.

Another known method of sharing files or personal digital information is via electronic mail communication and their associated attached files. The user sends an email and attaches the file to be shared. The email message recipient receives the email and shared file via an email server. This tends to be a more direct mechanism for sharing such information than the conventional centralized server approach where the user later requests the shared file. However, the email approach of file sharing is not without its own set of problems. Indeed, this email approach uses a “push” model for sharing the user's personal digital information. By doing so, the user may be forcing the information to be shared onto the recipient whether the recipient wants the information or not. Additionally, the email approach becomes an impractical file sharing solution when dealing with large sized files and large numbers of files.

A third approach to sharing files is the conventional “peer-to-peer” file sharing configuration. With this approach, the user and the viewer typically install proprietary file sharing software applications on their respective computers. The software on each computer forms a direct socket connection between the computers. However, in some instances, the socket connection may be facilitated by, or through, a “facilitating” device or central server. Once the connection is in place, shared files may be transmitted from the user's computer to the viewer's computer.

As with the other described prior art approaches, “peer-to-peer” file sharing has its own set of undesirable issues as well. For example, the software that is loaded on the user's and viewer's computers is proprietary and, in many instances, requires both the user and viewer to be online at the same time.

Another prior art approach is related to how instant messaging clients operate. It is common for an instant messaging client to make outbound socket connections to a central server, which transmits messages between clients. However, as with the “peer-to-peer” situation, it requires both the user and viewer clients to have special software and for both to be online at the same time.

Thus, there is a need for an improved system and method for easily sharing personal digital information from a user's computer.

### SUMMARY OF THE INVENTION

In accordance with the invention, a user's personal computer can be turned into a personal network server for easily sharing personal digital information with other people using a wide variety of networked devices. There are a variety of alternative ways in which such file sharing on the user's computer can be implemented, such as with a client-side server approach, a hosted server approach, and an automated publish approach. Depending upon a variety of factors (e.g., a selection from the viewer, empirically derived popularity of the requested shared data, the type of network device used by the viewer, etc.), the requested shared data may be intelligently and dynamically transformed to better fit the requesting party's needs. Programming interfaces are available to third parties that allow for access to the shared data and for providing customized instructions on what to do when transforming the data.

In one aspect of the invention, a system is provided for remotely accessing personal digital information that resides on a user computer. The system comprises a communication interface, a permission manager module and a connection manager module. The communications interface (e.g., a web server interface, an electronic mail interface, or an SMS gateway interface) receives a viewer's request for the personal digital information maintained on the user computer. The permission manager module is operatively coupled to the communication interface and operates by authenticating the viewer's request. The connection manager module is operatively coupled to the communication interface and the permission manager module, and maintains a connection (e.g., a persistent socket connection) to the user computer and receives the personal digital information from the user computer via the connection in response to a client request associated with the viewer's request. The connection manager module also provides the personal digital information in a predetermined format to the communication interface.

The system may also include a content transformation module operatively connected to the connection manager module. The content transformation module can alter the personal digital information from an initial format into the predetermined format prior to sending the personal digital information in the predetermined format to the communication interface.

The system may also include a content cache for storing the personal digital information in the predetermined format for use with a subsequent viewer request for the personal digital information.

In another aspect of the invention, a method is provided for remotely accessing personal digital information that resides on a user computer. The method begins by forming a socket connection between the users computer and a server computer. Next, a viewer request for the personal digital information is received from a third party computing device, In response, a request is initiated for the personal digital information using the socket connection. The personal digital information is then received from the users computer and provided in a predetermined format to the third party computing device.

The personal digital information may be received by the server in an initial format and transformed from the initial format to the predetermined format on the server before providing the information to the third party computing device. The personal digital information provided to the third party computing device may also be saved in a content cache for use with a subsequent request for the same personal digital information or updated with updated personal information from the third party computing device or the user computer.

It is to be understood that both the foregoing general description and the following detailed description are exemplary and explanatory only and are not restrictive of the invention, as claimed. Additional advantages of the invention will be set forth in part in the description which follows, and in part will be obvious from the description, or may be learned by practice of the invention.

The accompanying drawings, which are incorporated in and constitute a part of this specification, illustrate several embodiments of the invention and together with the description, serve to explain the principles of the invention.

### BRIEF DESCRIPTION OF THE DRAWINGS

FIG. 1 is an exemplary network architecture within which an embodiment of the present invention may operate.

FIG. 2, consisting of FIGS. 2A-2H, is a series of exemplary graphical user interface screen shots illustrating how to interact with an exemplary embodiment of the present invention.

FIG. 3 is a simplified network architecture diagram showing various software modules according to an exemplary embodiment of the present invention.

FIG. 4 is a block diagram of a client-side server configuration embodiment consistent with the principles of the present invention.

FIG. 5 is a block diagram of a hosted gateway configuration embodiment consistent with the principles of the present invention.

FIG. 6 is a block diagram of a centralized server configuration embodiment consistent with the principles of the present invention.

FIG. 7 is a diagram illustrating a content transformation engine module within the user's personal computer in an embodiment of the present invention.

FIG. 8 is an exemplary block diagram illustrating another embodiment of a hosted gateway configuration consistent with the principles of the present invention.

### DESCRIPTION OF THE EMBODIMENTS

Reference will now be made in detail to the present exemplary embodiments of the invention, examples of which are illustrated in the accompanying drawings, presentations, specifications and other technical documentation. Wherever possible, the same reference numbers will be used throughout the drawings to refer to the same or like parts.

In general, an embodiment of the present invention can turn a user's personal computer into a personal network server (such as an Internet server), thus enabling the user to easily share personal digital information with other people or systems using a wide variety of devices. Third party viewers may access the user's information by directly accessing the user's computer through a browser, email, SMS message or other Internet-enabled software program. The desired parts of the user's shared personal digital information can be transformed into an alternative format that best suits the viewer. As a result, another embodiment of the present invention requires no remote file storage, no remote hosting of other user content, and viewers need no proprietary software with which to access desired parts of the user's shared personal digital information.

General Networked Environment

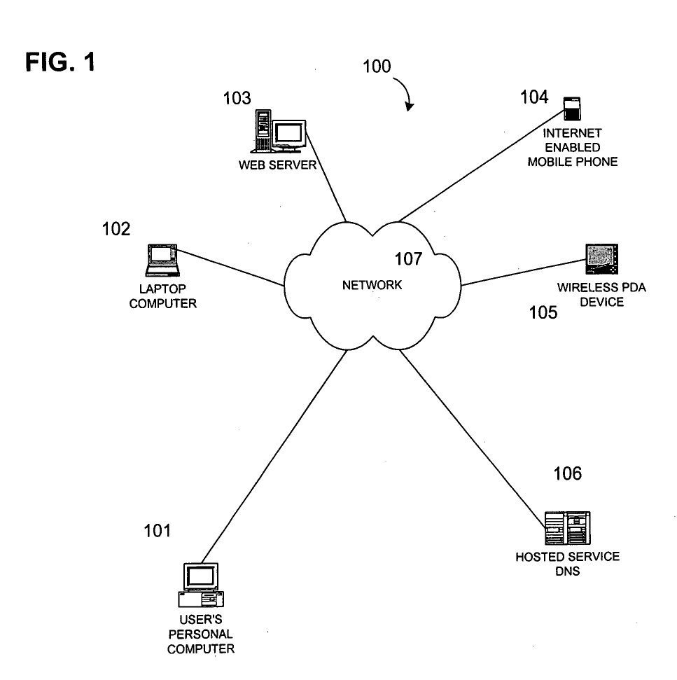

The operating environment for one or more embodiments of the present invention is a general network of computers and computing devices. FIG. 1 illustrates an exemplary network architecture within which an embodiment of the present invention may operate. Referring now to FIG. 1, the exemplary network architecture 100 includes the user's personal computer 101, a laptop computer 102, a web server computer system 103, an Internet enabled mobile telephone 104, a wireless personal digital assistant (PDA) device 105, and a hosted service domain name server (DNS) 106. Each of these networked computing devices are in communication with each other by means of a network 107, such as the global Internet, a local area network (LAN), or a wide area network (WAN).

The user's personal computer 101 includes data storage (not shown) for maintaining the user's personal digital information, such as the user's digital photographs. This personal digital information may be shared with other devices via the network 107. As noted before, personal digital information may include any type of data created by the user, such as a digital photographs or images, electronic calendar information, contact files, word processing files, video images, sound files, etc.

Using an embodiment of the present invention, third party viewers may receive information by directly accessing the user's personal computer 101 through a browser or other Internet-enabled software program. As a result, the embodiment of the present invention requires no remote storage, no hosting of user content, and viewers need no proprietary software on their own system to access the desired personal digital information on the user's personal computer.

When the personal digital information includes digital photographs or images, the digital photographs are automatically available online as soon as pictures are transferred from a digital camera (not shown) to the user's personal computer 101. One or more software applications or modules (not shown) within the user's personal computer 101 may automatically place the digital photographs in a user-friendly photo album format and make the albums Internet-accessible. The software application seamlessly operates in the user's desktop environment, allowing users to continue using their conventional photography software to manage and edit the digital photographs. Users may also customize the presentation of the digital photographs and may restrict access of specific parts of the personal digital information, such as limiting access to a particular album to certain individuals. Viewers may see pictures in multiple formats, email photos to others, print pictures, or order professional prints and photo merchandise.

In addition to providing third party access or sharing of the user's selected personal digital information, an embodiment of the present invention permits password-protected access for the user to their own personal files through any web browser, Internet-enabled device or SMS-enabled device. Furthermore, the embodiment utilizing the user's personal computer facilitates hosting of a personal web site created in Microsoft's Front Page or with any other hyper text markup language (HTML) editing program.

Other embodiments of the present invention may provide and support intelligent handling of other kinds of personal digital information, including digital video, music files, word processing documents, journals, electronic presentation materials, personal address book and calendar information, email message threads and contact management data.

In general, such a system may offer one or more benefits to the user and to the viewer requesting the personal digital information or content. First, the content is accessible once the content is placed within the user's personal computer. For example, digital photographs are automatically available online as soon as images are transferred from a digital camera to the user's personal computer 101. No additional steps are required.

Furthermore, no separate uploading is required because the content is served from the user's own computer. Users no longer have to upload content to a central server. Under normal circumstances, uploading is a tedious process and as users have more files, and larger files, this becomes an increasing issue.

Additionally, synchronization issues may be significantly reduced. In other words, users do not have to worry about synchronizing files with a central server. When using one embodiment of the present invention, the original file is the one that is accessed. Thus, if a user edits a digital photograph, the edited version is instantly available online to third party viewers, replacing the old version.

Shared content may be available through any browser and computer (e.g., laptop computer 102), as well as cell phones and PDAs (e.g., mobile phone 104 and PDA 105). Third-party APIs enable remote applications to directly access the shared personal digital information content on the user's personal computer 101.

When responding to a viewer's request for the user's personal digital information, an embodiment of the invention may automatically transform the requested content into a format that is relevant to the viewer device and application. For example, a digital photograph may be transformed from their original format into a thumbnail format so that it is easily viewed in a friendly photo album format when looking through a web browser. Likewise, the digital photograph may be transformed into an MMS message when the request is from a mobile phone. When attempting to access the digital photograph for printing purposes, the digital photograph may be provided as a high-resolution image suitable for high quality printing.

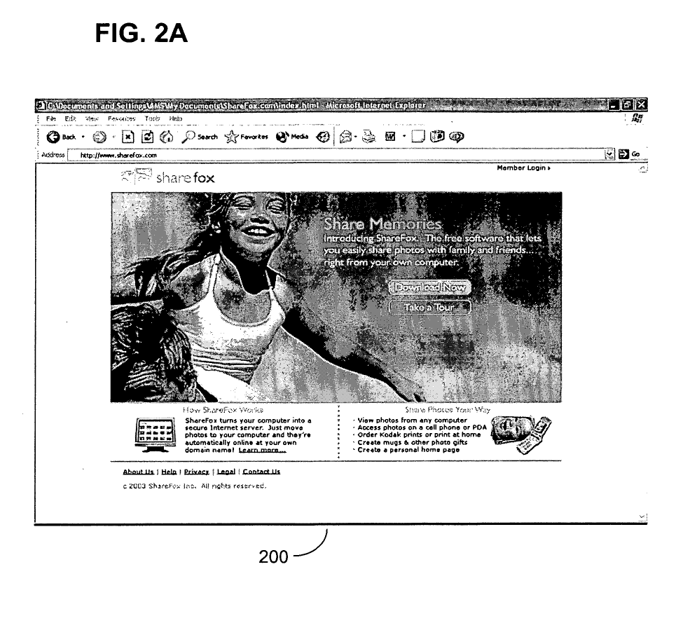

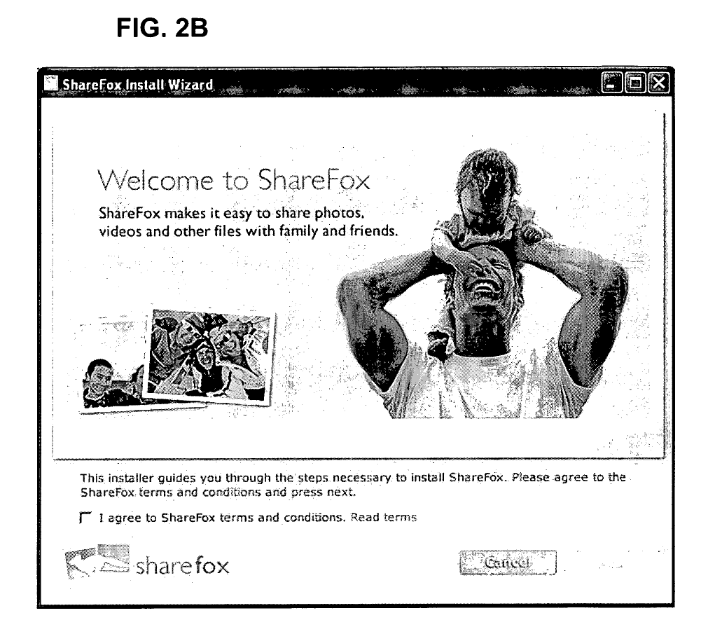

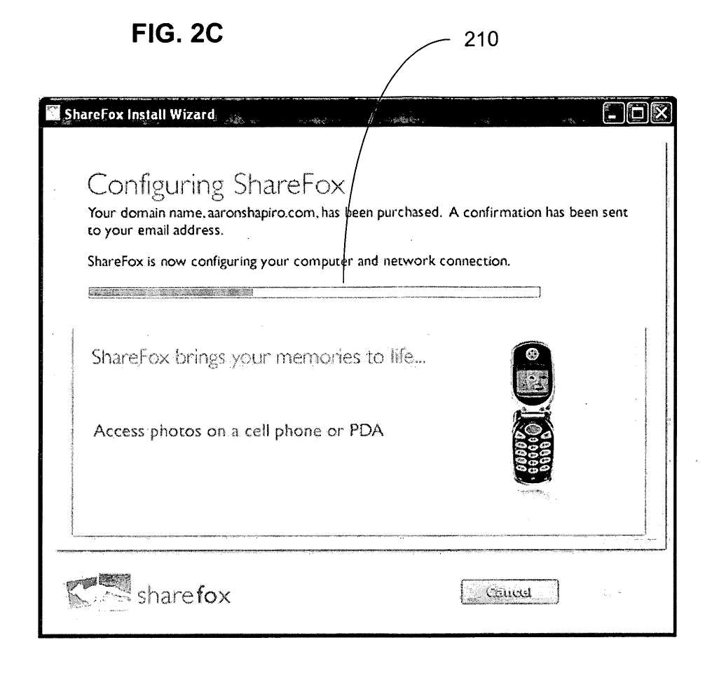

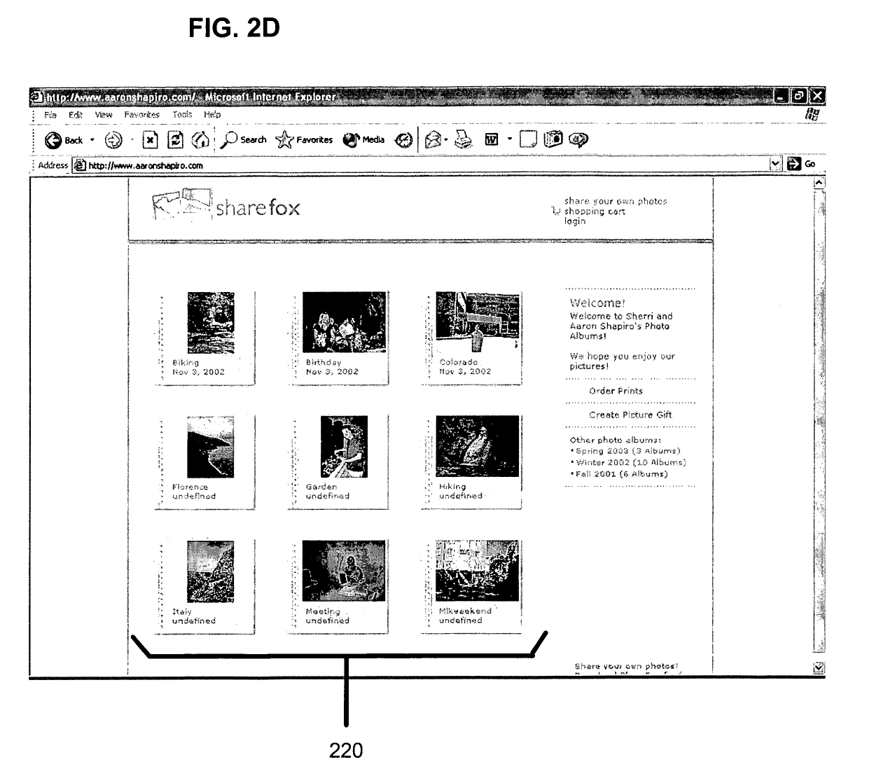

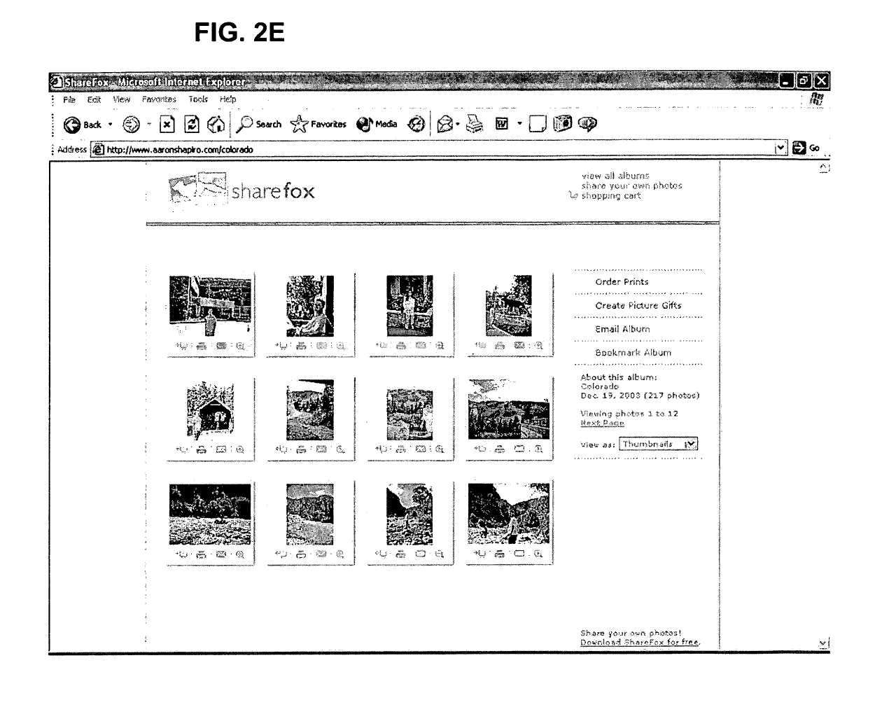

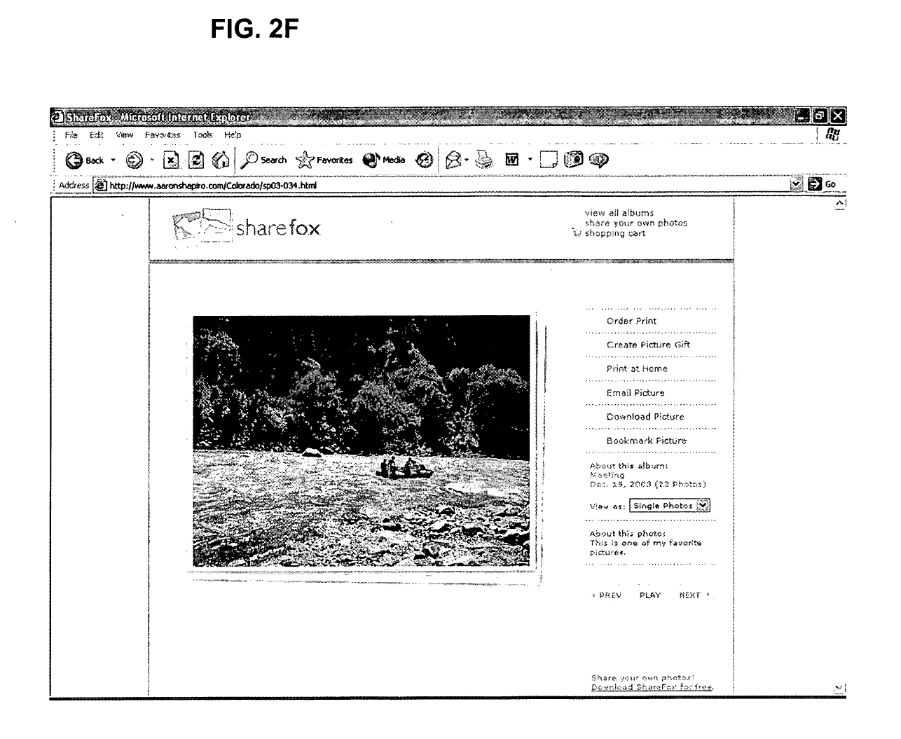

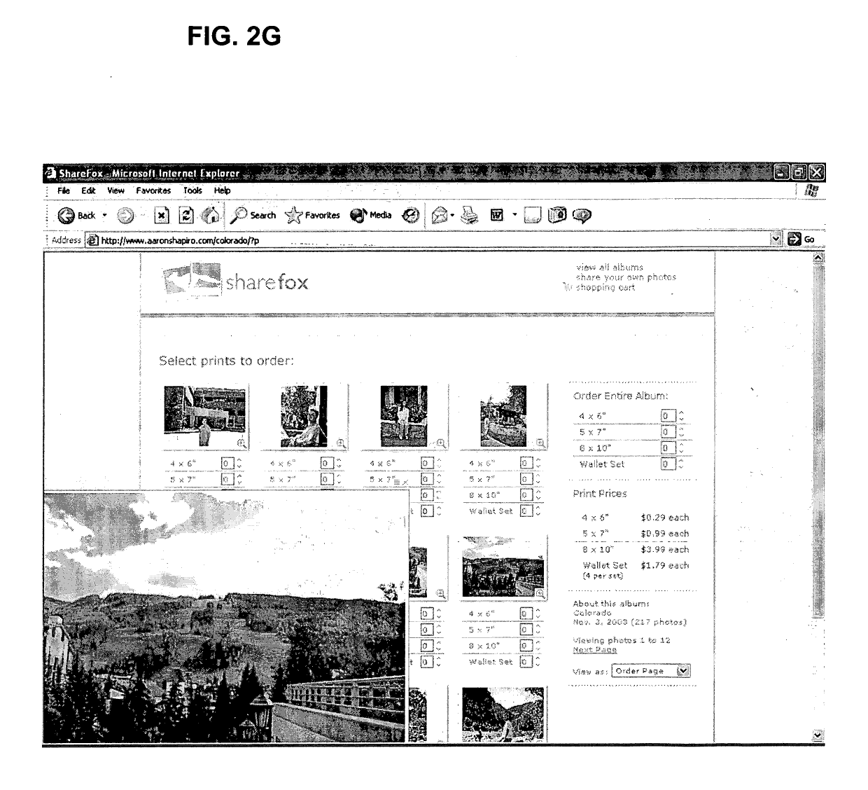

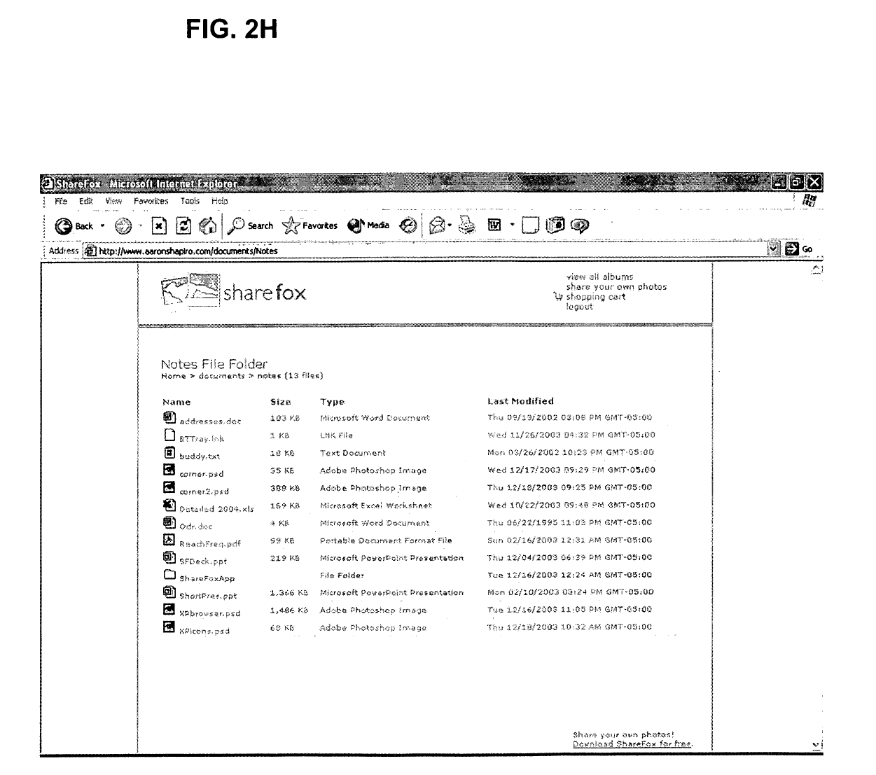

In FIGS. 2A-2H, an exemplary series of graphical user interfaces are shown that may appear when interacting with an embodiment of the present invention. Referring now to the embodiment illustrated in FIG. 2A, a user is able to use a network browser to show an installation wizard in display window 200 when the user wants to install the software modules necessary for an embodiment of the invention. By clicking “Download Now” within window 200, the installation wizard takes the user to FIG. 2B where the user agrees to terms and conditions for use of the software modules.

In FIG. 2C, the software modules have been downloaded and a configuration screen 210 appears as the software modules learn how the user's personal computer 101 is setup and how it is connected to the network 107. Once this is complete, the user can identify what type of personal digital information (more generally called “content”) should be made available for viewing and sharing. Using the software modules, the user may create a domain name associated with the user's personal computer so that a viewer can “visit” and review any shared content. For example, a viewer can connect to the user's personal computer 101 and view the shared content, such as the digital photograph albums 220 shown in window 200 of FIG. 2D.

If the viewer wants to access (view, modify, transmit a copy as an e-mail attachment) the shared content, the viewer can do so with a request to the user's computer, such as a mouse click over the desired thumbnail image in albums 220. In an example, a visitor wishes to see one of the family photographs from one of the albums 220. The photographs are stored on the user's computer as a bitmap (BMP) file in 300 dpi resolution, at 1704×2272 pixels (a common size for an image taken by a 4 Megapixel digital camera). This file would be transformed into a smaller JPEG formatted file (72 dpi resolution, and 600×450 pixels) so it can be properly viewed in a web browser. In this manner, the user's personal computer 101 responds to the request by providing a different format of the album's images as shown in FIG. 2E. In another example, the content of the selected album may be viewed in a full-screen slideshow (not shown) or displayed in a group at a lower resolution (as see in FIG. 2E).

If the viewer wants to see a particular digital photograph from the album, as shown in FIG. 2F, the viewer selects that particular image from the album of thumbnail images of FIG. 2E. If the viewer wants to order prints of the selected image, the software modules in the user's personal computer 101 may display a print/order interface as shown in FIG. 2G.

When sharing other types of personal digital information, the viewer may be faced with an alternative type of display that shows personal digital information in a directory-like window. For example, FIG. 2H illustrates an exemplary directory-like window listing shared personal digital information, such as word processing documents, digital photographs, and presentation materials. Thus, from the user or viewer's perspective, embodiments of the present invention provide an easier way to share and gain access to shared personal digital information.

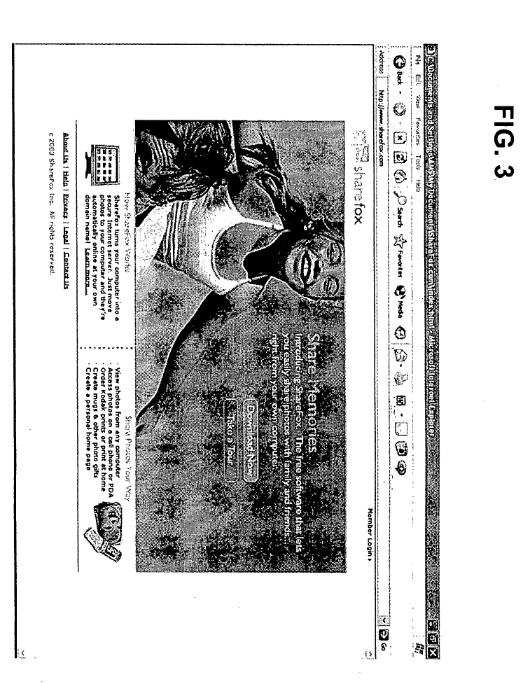

Looking at the user's personal computer 107 and how it interacts with other computers on network 107, FIG. 3 illustrates exemplary functional relationships between the user's personal computer, and the hosted service DNS 106 according to an embodiment of the present invention. Referring now to FIG. 3, the user's personal computer 101 includes several software modules, such as server module 202, content manager module 203, administrator module 204, and integration module 201. In an exemplary implementation of an embodiment of the present invention, these software modules were developed in the C# programming language, using the Microsoft .NET development platform. Information or data used by these software modules can be stored in XML documents.

Looking at the functionality of the software modules in more detail, FIG. 3 illustrates an example of a simplified network architecture having functionally related elements in accordance with an embodiment of the invention. Referring now to FIG. 3, the user's personal computer 101, the laptop computer 102, and the hosted service DNS 106 are connected via the Internet 107. A suite of software modules may be installed within the user's personal computer 101 to implement the personal server functionality of an embodiment of the invention. In one embodiment of the invention, the software modules include an integration module 301, a server module 302, a content manager module 303, an administrator module 304, a content transformation module 305, and user files 306.

The integration module 301 integrates the sharing functionality throughout the operating system of the user's personal computer 101 and other applications on the user's personal computer 101. The functionality of the integration module 301 may also include one or more of the following:
An icon shown on the desktop (or in the Windows System Tray) of the user's personal computer that allows easy access to global file sharing controls.
An icon shown in an email application (e.g., Microsoft OUTLOOK) of the user's personal computer gives users the ability to email files through file sharing. Rather than sending a file attachment, a link to the user's shared content is placed in the email message. This eliminates the need to transmit the actual content, thus ensuring the email message will not be rejected due to size restrictions on the recipients email account.
Users can share, email or order prints by right-clicking on a folder or file.
Email and sharing controls are added to other applications, such as Microsoft EXCEL, WORD and POWERPOINT, as appropriate.
Web publishing applications, such as Microsoft FRONTPAGE and Macromedia DREAMWEAVER, can “publish” content directly to the user's computer as a server, and can also be used as tools to create content templates.

The server module 302 accepts inbound requests (such as a request from laptop computer 102), passes the requests to content transformation module 305, which then collectively returns the requested content in a format that is transformed or tailored according to a predetermined relationship. For example, the content may be transformed from a first format to a second format according to the viewer's application and device. In one embodiment, a template system may be used to display content in specific formats, such as a photo album or web directory structure. The user can customize templates. The server module 302 and/or the content transformation module 305 also maintains permissions and access controls related to specific content. For example, in one embodiment, specific content can only be accessed by first entering a username and password, while other content is available to the public.

The server module 302 handles the request in conjunction with the content transformation module 305 via mapping to the requested content. Generally, the server module 302 maps requested URLs to the directory structure of the user's personal computer 101 using the content transformation module 305. In one embodiment, a photo album is assumed to be a single directory that primarily contains one or more digital images. This mapping gives users an intuitive understanding of the manner in which content is shared on their computer, without needing to understand the technical nuances of a server.

The server module 302 and content transformation module 305 may also support intelligent handling of other content types, such as:
Home videos, displayed in a “video jukebox” format, with video resized and streamed to viewers;
Audio and other MP3 files, available for streaming or download;
Presentation documents viewable in web-friendly format, with real-time presentation capability;
Word processing documents, displayed in a blog/web journal format, or as full web pages;
Spreadsheet files viewable in web-friendly format; and
Contact management data, including contacts, calendars, tasks and email available online.

While the illustrated embodiment of the present invention shown in FIG. 3 has the server module 302 and the content transformation module 305 being separate and distinct software modules, those skilled in the art will quickly appreciate that other embodiments of the present invention may implement the functionality of these modules into a single module.

An embodiment of the present invention is designed to seamlessly run behind-the-scenes with no ongoing management or configuration required. It is assumed that users continue to use their existing photo editing and content management programs. However, some users may want more advanced control of the way in which their content is accessible. The content manager module 303 may give users this desired level of control.

In one embodiment, the content manager module 303 has the following functionality:
Import photos from a digital camera, which are then immediately available online;
Password-protect, share or hide specific directories on the user's personal computer 101;
Define the templates that are used for display content, and the manner in which content is transformed;
Create new photo albums and directories;
Copy and move files between photo albums and directories; and
Assign attributes to photos and photo albums, such as a name, description and author.

The content manager module 303 may also give users access to system usage statistics. As a result, a user can determine when specific files have been accessed, how often, and, if it is password protected content, by whom.

The administrator module 304 within the user's personal computer 101 may monitor system performance to ensure optimal connectivity and security integrity. In one embodiment of the present invention, the administrator module 304 includes the following functionality:
Maintenance of continuous network connection;
Monitoring of bandwidth, CPU and memory usage to ensure the server does not impact the performance of other applications used by the user on their computer;
Monitoring a network IP address, which is communicated to the hosted service DNS server 106 to maintain network availability;
Installation and update of software enhancements;
Execution of diagnostic routines to minimize server crashes and errors; and
Transmittal of critical error logs to the hosted service DNS server 106 for diagnostic purposes.

The hosted service DNS 106 is useful as noted above and in other ways. For example, the hosted service DNS 106 performs network, performance-optimization and security-oriented tasks that make the file sharing system on the user's personal computer perform as servers, working in conjunction with the administrator module. For example, the hosted service DNS 106 may monitor network availability and point out the correct address for the user's personal computer when a viewer requests some of the user's shared personal digital information (i.e., provide a domain name resolution service for viewer requests).

In another embodiment of the present invention, the hosted service DNS 106 may also be a conduit for providing a variety of value-added services. These are fee-based offerings which are offered directly by the supplier of the file sharing system software or in partnership with third-party providers. Services include:
Domain name registration services, allowing the server module 302 to be accessible at the user's personal domain name;
Automated caching of frequently accessed content, which dramatically improves the response time experienced by the viewer;
Integration with the selected photo processing partners, allowing viewers that use the file sharing system to easily order prints and print-related merchandise;
Automated remote backup of user's personal digital information;
Management of mail exchange (MX) records and alternate port routing for inbound and outbound mail, allowing users to run their own mail servers; and
WAP/SMS/MMS gateway for delivery of mobile phone-accessible content from the user's personal digital information.

While the hosted service DNS 106 has many different uses, as noted above, the service is used differently depending upon how the file sharing system is configured upon installation.

Installation & Configuration

In an embodiment of the present invention, the above-reference software modules are installed within the user's personal computer 101 and then configured based upon the network connection implementation (e.g., firewalls, routers, etc.). Ideally, the installation process is designed to be a one-click setup process requiring no technical expertise. The installation process sets up the computing environment to accept inbound HTTP connections from any viewer (e.g., the laptop 102, the web server 103, the Internet-enabled mobile phone 104, and the wireless PDA 105) and allows the viewer to access the shared content that resides on the user's personal computer 101.

Looking at an exemplary configuration process in more detail, the user's personal computer 101 may scan for TCP/IP ports in use or blocked and select a port that will be utilized by the downloaded software modules (collectively referred to as “the file sharing system”). The user's personal computer 101 may then modify any existing firewalls to allow inbound requests on a specified port to be handled by the resident file sharing system. Additional security software may be added to the file sharing system for added protection. In one embodiment of the present invention, the file sharing system is installed as a Microsoft WINDOWS SERVICE, so it continually runs as a background process on the user's personal computer. Those skilled in the art will appreciate there are other mechanisms for implementing such a file sharing system using alternative processes, code, and software modules.

Configurations

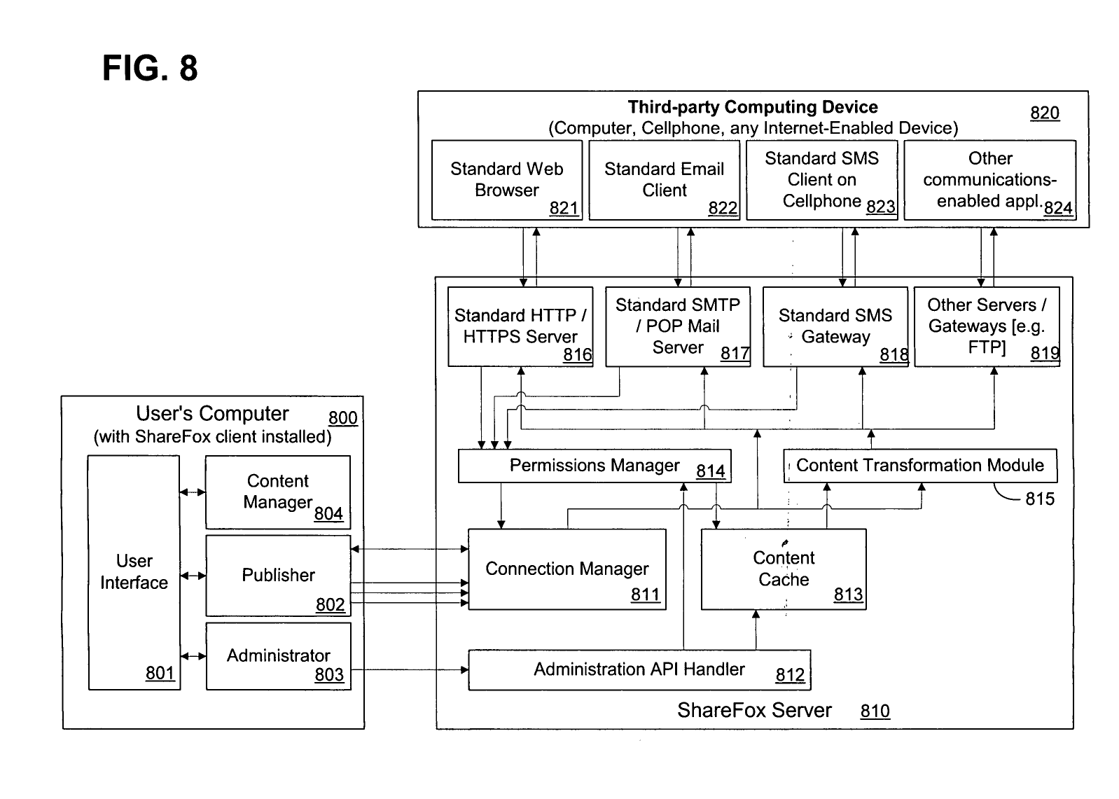

In general, the following includes a description of four example types of file sharing configurations that can be implemented when installing the file sharing system based upon the existing configuration of the user's personal computer and examination of its network connections. Specifically, these include a client-side server configuration, a hosted gateway configuration, an automated publish configuration, and a hybrid configuration. An additional example of the hosted gateway configuration is further described in more detail with regard to FIG. 8

Depending upon the implementation, some configurations may be more suited than others. For example, in some cases, there may be difficulty configuring the client-side configuration to support true HTTP web serving technology. For instance, the client computer may be behind a corporate firewall, or the home-computing environment may utilize a non-standard router or a dial-up connection. In such a situation when the client-side configuration is not possible or may pose difficulties, the software on the user's computer forms a persistent socket connection with the hosted service DNS. The hosted service accepts and serves all HTTP requests for content, dynamically retrieving needed content through the secure socket. Caching is used to minimize socket communications.

In other situations where the persistent socket approach may be difficult to implement in the user's particular environment, the administrator module may monitor the user's shared directories and dynamically upload new and revised files to the hosted service DNS 106. Files are then directly served from the Hosted Service. While this approach enables sharing, it may have less than desired performance when dealing with large numbers of big, frequently changing files. As a result, system throttling and user feedback may be used to set appropriate expectations.

Client-Side Server

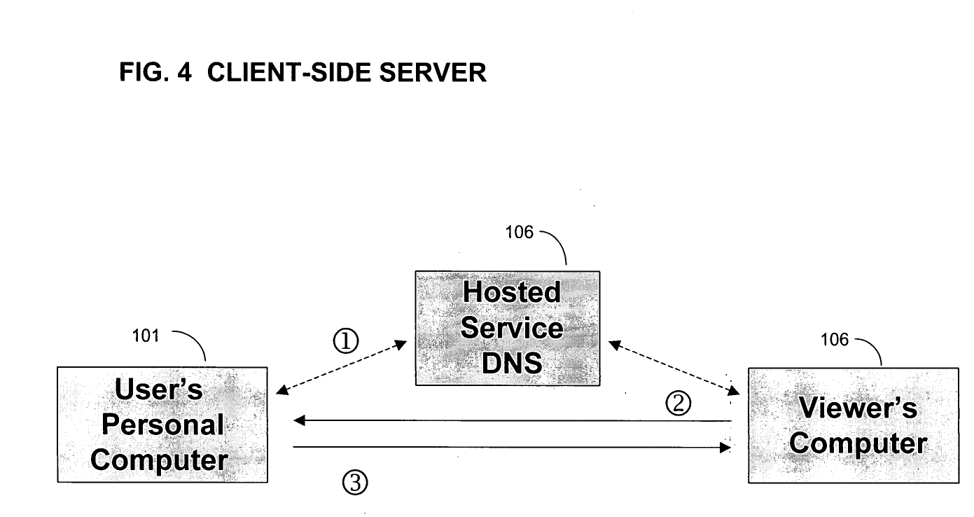

FIG. 4 is related to a more detailed explanation of the client-side approach. Indeed, FIG. 4 illustrates a block diagram of an exemplary client-side server installation consistent with the principles of the present invention. Referring now to FIG. 4, the viewer using laptop 102 may request a file (a portion or all of the user's shared personal digital information). The hosted service DNS 106 informs the laptop 102 that the request is for the user's personal computer 101. Upon receipt of the request from the laptop 102, the user's personal computer 101 transforms the requested file to an appropriate or desired format. The user's personal computer 101 transmits the transformed file to the viewer's laptop 102 where it is viewed in a browser. In this way, the software modules on the user's personal computer 101 configures the network and that computer to enable server functionality.

Hosted Gateway Configuration

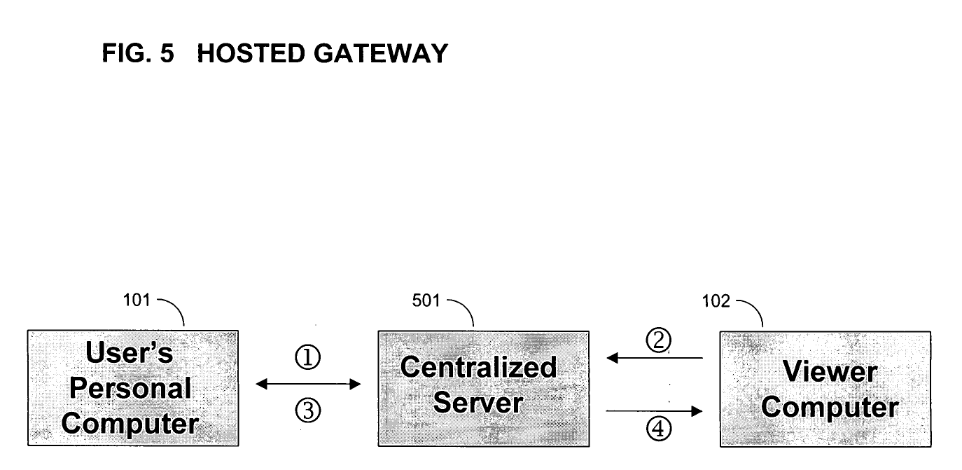

FIG. 5 is a block diagram of an exemplary hosted gateway installation embodiment consistent with the principles of the present invention while FIG. 8 illustrates an alternative embodiment of the hosted gateway installation consistent with the principles of the present invention. Referring now to FIG. 5, the software modules resident on the user's personal computer 101 form a persistent, secure socket connection with a centralized server 501. The number of socket connections between the centralized server 501 and the user's personal computer 101 should be more than one to accommodate simultaneous requests for files and increased viewer traffic. Thus, the hosted service 106 accepts and serves all HTTP requests for content, dynamically retrieving needed content through the secure socket. Caching may be used to minimize socket communications.

Next, the viewer requests a user file (a portion or all of the user's shared personal digital information) through a web browser by contacting the centralized server 501. The centralized server 501 passes the request to the user's personal computer 101. In this embodiment, it is important to recognize that the user's shared personal digital information (more generally referred to as “data” or “files”) remain on the user's personal computer 101 and not on the centralized server 501.

In response to receiving the request, the user's personal computer 101 locates the requested file, transforms the format of the file into a desired or appropriate format, and then sends the transformed file back to the centralized server 501. Finally, the server 501 transmits the transformed file back to the requesting viewer's laptop computer 102.

Automatic Push Configuration

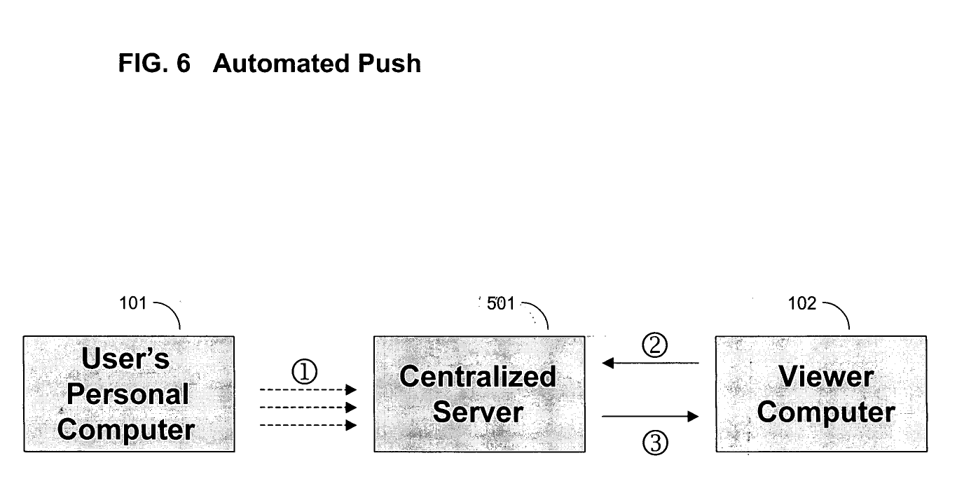

FIG. 6 is a block diagram of an exemplary automated publish installation embodiment consistent with the principles of the present invention. Referring now to FIG. 6, the software modules on the user's personal computer 101 monitor particular files (i.e., files that are meant to be shared) for any changes or updates. When a file changed and the change is detected, the revised file is sent to the centralized server 501. Similarly, when a new file is created and it is of the type to be shared, the new file is sent to the centralized server 501. Thus, when a viewer requests a particular file, the centralized server 501 receives the request and provides it back to the viewer. In this embodiment, the centralized server 501 may transform the format of the file into another desired or appropriate format, and then send the transformed file back to the centralized server 501.

Hybrid Configuration

In yet another embodiment of the present invention, a hybrid configuration may be implemented. The hybrid configuration may utilize a combination of two or more of the file sharing configurations described herein to achieve a high throughput and, thus, is optimized for high-volume requests. For example, if a file is frequently requested, that file may be cached on the server 501 in either the hosted gateway configuration or the automated publish configuration. When such cached files are changed on the user's personal computer 101, a newer version of the file is transmitted or “published” from the users personal computer 101 to the centralized server 501 for caching.

General Operation

An embodiment of the system generally operates by serving the viewer's request, finding the shared content, transforming the content, and returning the transformed content to the requesting viewer. A request is generally in the form of an HTTP request or web services request. In more detail, those skilled in the art will appreciate that a request using standard HTTP protocol has a header, which contains the requested URL, requesting source and other related information. The header could contain variables in the URL (as defined by the computer system), or, if it is a HTTP POST request, then the variables are name-value pairs as part of the request content. The speed of the network connection can be determined by network response time, and the layout can be determined based on the sent variables as well as those from the requested source.

As an example, a request for a photographic image may be formatted as follows: hello.jpg?width=100&height=24. The requested page is album.html and the requested client is Mac OS X Safari. With this information from the request, the computer system should return the image as a specific width and height, using the album.html template, and needs to transform the content of the image to be in a format that's compatible with a Mac Safari browser environment. If the requesting URL would not include width and height, the appropriate width and height may be inferred or set by default to predetermined values.

In one embodiment, the software modules make extensive use of XML configuration files, which define the manner in which content is shared, including URL location, permissions, templates and content metadata. Each content folder can contain a hidden configuration file that defines configuration information for the content saved in the folder. As a result, any desktop application can read and modify these files, changing configuration accordingly. Similarly, changes in the user's file and directory structure are automatically reflected in system's file sharing capabilities. In the case of a web services request, XML data may be sent as part of the request. This data would include variables that would define how to transform the content.

Furthermore, it is advantageous to transform or convert the requested personal digital information in the user's files 306 from an initial format to another format. While the transformation to another format can be achieved on the fly (in response to each request), there may be further performance advantages to performing a batch pre-conversion to a secondary or predetermined format. For example, automatically transforming any picture to a standard thumbnail sized image allows for a quicker response to a viewers request. In this manner, the thumbnails can be cached and ready for immediate use so that it appears to be an instantaneous transformation of the picture. Furthermore, it may make sense to pre-convert a very popular image to a number of different sized pictures—especially if you are attempting to sell them online. As a further enhancement, the user's personal computer 101 may empirically determine popular formats based upon a history of requests and pre-convert the image accordingly for use with subsequent requests. The transforming operation can be not only to a routinely desired size, it can also automatically and dynamically be performed to transform the normal image.

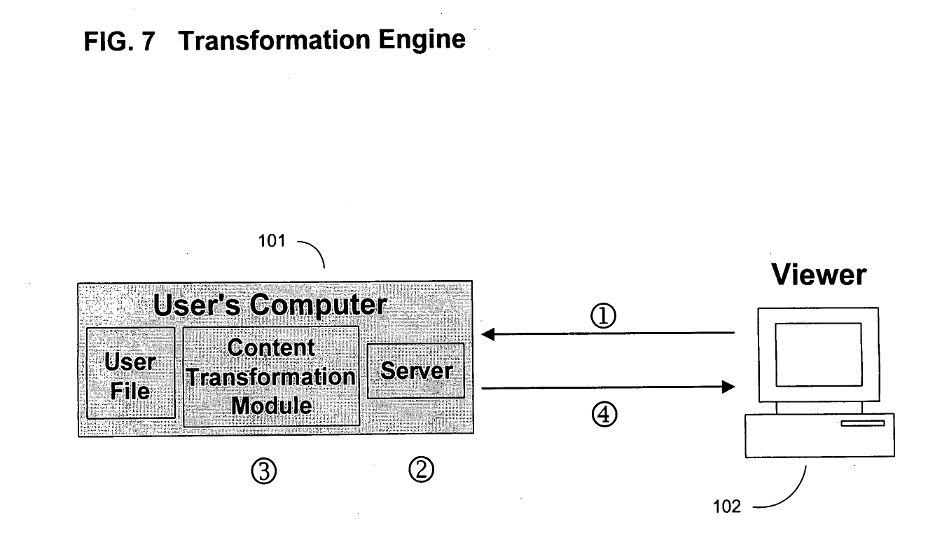

In one embodiment of the present invention, there is a system and method for intelligently and adaptively transforming such personal digital information in personal web serving environment. As shown in FIG. 7, from a transformation perspective of an embodiment of the present invention, the method begins when the viewer requests content from an Internet-enabled device (e.g., laptop 102, PDA, 105, etc.). Upon receipt of the request, the software modules (e.g., modules 301-306 performing as the file sharing system) assess the request for the following information:
What is the requesting device & software? (mobile phone, PDA?)—note, this may be found in the header of the request message;
What is the requesting connection speed?
What type of content is requested (high resolution photograph, low resolution photograph, video, etc.)?
What is the intended use (display? printing, etc.)?
Any special user instructions? (e.g., use a specific template or format; block any requests from specific viewers)

Next, the content transformation module 305 accesses the correct file from the user's data 306, transforms the file to the appropriate or desired format, and returns the transformed file to the viewer. The transformed file may be saved to a cache for later use with subsequent requests.

Programming Interfaces

The software modules making up this file sharing system are built with an extensive set of programmable interfaces. While these APIs allow third-party development of modules that extend the systems functionality, other APIs also enable third-party applications to easily access the share-enabled content.

The system's web services interface allows remote third-party applications to access content made available through such a system. In one embodiment, the first implementation of this interface is the Photo Screensaver. The Photo Screensaver can access photos from any user's computer and display these pictures as a screensaver on the viewer's computer. For example, a grandparent can set their screensaver to show new pictures of his or her grandchildren, and the photos are directly accessed from one or more ShareFox servers installed on remote machines.

Those skilled in the art will appreciate that server APIs are a programming interface that allows third-party developers to create custom instructions for the delivery and display of files with a specific MIME type or specifically requested URLs. For example, the APIs can be used to extend ShareFox functionality to allow collaborative calendaring.

Automatic Sharing Technology

Current methods of making personal digital information available online (e.g., an online photo album) typically require multiple steps. For example, a typical system that shares personal digital information requires a selection of files and folders, which may be formatted into a desirable HTML format suitable for sharing (e.g., a lower resolution for displaying multimedia data without incurring undesirable delays while display processing the files and folders). The system then specifies that the formatted files and folders are to be uploaded to a server and selects an appropriate address (e.g., a conventional URL) for accessing the formatted files and folders. Some user-friendly systems have a software interface where users select files and folders they wish to publish, and the content is then automatically uploaded to a central server and correctly formatted so they are available online. One problem faced by such systems is that every time the user creates or modifies the content, the user must manually update what is available online or tell a third party system to publish the updated content when creating new files/folders or modifying existing files/folders.

An embodiment of the present invention may dynamically monitor the user's desktop computer 101 (e.g., hardware subsystems within computer 101 and/or any software application or module operating in the computer 101) to detect when new photos, documents or other personal information are created, modified, or deleted. For example, such monitoring may be implemented using a background software process or a specially designed circuit that responds to memory access transactions across a bus. Once a new file/folder (or modified file/folder) is detected, an embodiment of the invention may respond by automatically making the new file/folder (or modified file/folder) available online through one or more of the above-described methods. In one particular embodiment, it is contemplated that once new files are detected, they may be loaded onto the Hosted Service DNS 106 so that the new files are made available online. In this manner, the user is free to update, modify, and create content without having to worry about manually updating what is available to be shared online.

In another embodiment of the present invention, the content manager module 303 may be used to maintain and administer global or local sharing settings on a static or dynamic basis. For example, any new files or folders in the user's “My Pictures” directory may be made available online while new files or folders in the user's “My Music” directory may not be available online without a password or other security measure. Further, any new files or folders in the user's “My Secrets” directory would not be made available online at all.

Such a set of rules or settings may be established and kept static or may dynamically change depending upon the requesting party's identity, time of day, or other selectable parameter. These rules or settings may be saved in XML files so that a user or third party may directly edit the XML files to cause a change in settings. Furthermore, the rules or settings (also referred to as permissions) may be set directly by right-clicking on a file/folder in the WINDOWS operating system environment and choosing the appropriate sharing permissions as a property or other attribute of the selected file/folder.

### Alternative Hosted Gateway Embodiment

In yet another embodiment of the present invention, an alternative implementation of a hosted gateway configuration can be illustrated with the system architecture as shown in FIG. 8. Referring now to FIG. 8, the architecture consists of a client module 800 (e.g., an implementation of which is referred to as a ShareFox Client) and a server module 810 (e.g., a implementation of which is referred to as a ShareFox Server). The client module 800 is installed on the user's computer while the server module 810 is installed on another network device that hosts requests from third parties.

In this implementation, the ShareFox Server 810 is designed to run in a high-performance server computing environment, which can receive and rapidly process large numbers of Internet transactions. The ShareFox Server 810 can be housed in a single, centrally-accessible computing facility that can interact with many ShareFox Clients 800. Alternatively, the ShareFox Server 810 may be installed in corporate computing environments, serving a smaller number of ShareFox Clients 800.

Generally, content is requested by a veiwer's request from a third-party computing device 820. This request is received by the ShareFox Server 810, which in turn accesses the ShareFox Client 800 to retrieve the requested content. The content is returned by the ShareFox Server 810 to the third-party computing device 820.

In embodiment, the ShareFox Client 800 is developed in C# using the Microsoft .NET development platform running on any WINDOWS 2000, WINDOWS 2003 or WINDOWS XP computer with the .NET runtime environment installed. In this implementation, the ShareFox Server 810 is developed in Java using Java Servlet technology and compatible with the Java 1.5 Runtime Environment. The architecture runs on a single Linux Server, or collection of Linux servers with Apache Tomcat or similar Java Application Server installed, MySQL or similar database, SendMail or other standard SMTP/POP mail program, and an API connection to a third-party SMS gateway. Those skilled in the art realize that the ShareFox Client (more generally referred to as the client module) and the ShareFox Server (more generally referred to as the server module) can be effectively implemented in other computer and technology platforms. The minimum requirement for the ShareFox server architecture is that it runs on a computing device that can accept inbound socket connections.

In another embodiment, those skilled in the art will realize that it is possible, with the addition of a Dynamic DNS server to the ShareFox Server 810, to configure the ShareFox Client 800 and ShareFox Server 810 into a unified software application (which may be implemented as one or more software modules) and utilizes the combined software as a peer-to-peer application, where clients who cannot receive inbound socket connections have requests routed through computers that have the combined ShareFox architecture installed and can receive inbound socket connections.

Any device having communications capability, such as Internet, SMS or other wired/wireless connectivity to networks, can be used as third-party computing device 820, to retrieve content from the user computer. Examples of third-party computing devices include, but are not limited to, a personal computer, a server, a laptop, wireless PDA, or other handheld device, a television set-top box such as Tivo digital video recording system, a Sony Playstation game system, or a mobile telephone.

When using the third-party computing devices, requests can be made for user content using standard Internet applications including: a Web Browser 821 (such as INTERNET EXPLORER from Microsoft or FIREFOX from Mozilla); an email program 822 (such as Microsoft OUTLOOK); an SMS Client 823, which is a common feature of most mobile phones; or another type of communications-enabled application 824, such as an FTP client. Other standard electronic communication paradigms, such as instant messaging could also be utilized, with the addition of a customized gateway on the ShareFox Server 810. A custom application or third-party software product could also request user content from the ShareFox Server through its API.

In one embodiment, the ShareFox Server 810 essentially consists of several software modules: a connection manager 811, an administration API handler 812, a content cache 813, a permissions manager 814, a content transformation module 815, an HTTP/HTTPS server 816, an SMTP/POP email server 817, SMS gateway 818, and other servers/gateways 819.

Those skilled in the art will appreciate that the HTTP/HTTPS server 816, SMTP/POP email server 817, SMS gateway 818 and other servers/gateways 819 are essentially types of communication interfaces that may receive requests for user content from the third-party computing device 820, such as a computer, cell phone or any Internet-enabled device. These requests can be standard HTTP/HTTPS requests, email messages, SMS messages, or other requests using any other data communication protocol, such as a direct TCP/IP/UDP socket connection, or an FTP request. The architecture may further be designed so the ShareFox Server can be extended to support a variety of specific protocols. For example, a ShareFox Server gateway extension can be developed to allow user content requests to be received from Instant Messenger programs such as Yahoo! Instant Messenger, AOL IM, or Jabber.

The requests received by the appropriate server/gateway are forwarded to the permissions manager 814. The permissions manager 814 authenticates the request and ensures that the requesting party has permission to access the user personal information [or has appropriate rights to change or modify the content]. If the permissions manager 814 determines that the requesting party does not have access, the permissions manager 814 will reject the request or ask for authentication information.

If the request is valid, the permissions manager forwards the request to the content cache 813. The content cache 813 maintains a copy of frequently-accessed user content, to facilitate rapid and efficient delivery of said content. If the user content is contained in the content cache 813, the requested personal user information is retrieved and forwarded to the content transformation module 815.

If the requested information is not available in the content cache 813, the request is forwarded to the connection manager 811.

The connection manager 811 maintains and manages all socket connections initiated by a publisher 808 part of the ShareFox Client 800. Management entails the maintenance of the persistent socket connection created by the publisher 802 and connecting to the connection manager 811. It also entails the receipt and processing of socket connections made by the publisher 802 to the connection manager 811 that actually transmits requested content.

As the connection manager 811 receives personal content from the ShareFox Client 800, the content is transmitted directly back to the requesting server/gateway [816-819]. The requesting servers/gateways [816-819], in turn, transmits the content to the requesting third-party computing device 820. Optimally, content is transmitted to the requested/gateway server as it is received. If the requested/gateway utilizes an instant request/response mechanism to deliver content (such as an FTP server or HTTP/HTTPS server), these servers begin responding to the requesting third-party computing device 820 as it receives content from the connection manager 811. As a result, the third-party computing device 820 receives content from the ShareFox Server 820 as it is transmitted from the ShareFox Client 800 to the ShareFox Server 810.

For third-party computing devices 820 requesting content using a messaging protocol (such as email or sms), the appropriate server/gateway on the HTTP/HTTPS server will wait to receive the all the entire piece of the content from the connection manager 811 before delivering a response, since these protocols are message-based and so cannot accept a streamed content delivery.

Some content requested by third-party computing devices 820 may require content transformation before delivery for effective display of data. An example of this is the request for an HTML page or graphic from a web browser tailored to a specific cell phone. Because of the cell phone's screen size and limited capabilities, this environment will may not be able to successfully display a web page that is tailored to a standard desktop browser. In this case, the connection manager 811 transmits the requested content to the content transformation module 815 instead of directly transmitting to the server/gateway interfaces 816-819.

The content transformation module 815 receives the requested content from the connection manager 811 and transforms the content into a format optimized to the requesting application, device and protocol. For example, a photograph may be reduced in size to support a small cell phone window. HTML may be formatted into a simple layout to support basic WAP mobile browsers. In another example, a requested music file may be reduced in resolution to reduce the memory required while meeting the lower audio capabilities of the third-party computing device (e.g., an Internet enabled PDA or wireless music player).

To facilitate content transformation and accurate retrieval of user content, the connection manager 811 can also request, and receive from the ShareFox Client 800, XML files that include the names and locations of files, folders and associated meta-data for available content.

Retrieved XML files can also respond to specific search queries for available files [for example, return all Microsoft WORD document files with the name starting with “Notes” and created between a specific date range]. Search queries can be based on file and folder attributes, content meta-data as defined in a user interface 801, or can be derived from searching any text contained in requested user information. As the Content Transformation Module 815 transforms content from the initial format into the final format (also known as a pre-determined format), it is delivered to the requested server in a manner similar to the situation in which the Connection Manager 811 directly returns content to the requesting server.

The ShareFox Client 800 consists of four software modules: the user interface 801, publisher 802, administrator 803 and content manager 804. The user interface 801 is utilized by the user to define the manner in which content is shared, and all permissions and rights access associated with content. For example, the user can determine that all digital photos in a particular folder are accessible to the public, without password, which certain Microsoft WORD documents can only be accessible by specific users. Permissions and rights access for content can define any number of individuals or systems that have the ability to access or modify a given file. For file folders, the user can define any number of individuals or systems that have the ability to access the folder's contents or modify what is in the folder or save to the folder.

The user interface 801 can be used to define meta-data associated with user content. Meta-data can include a description of a file, the date in which the file was created, or the photographer of a picture. Meta-data is used in other parts of the ShareFox system in the presentation, identification and search of content. However, assignment of meta-data to content is not required for ShareFox to successfully share content.

The user interface 801 may be used to define the manner in which content is presented. This includes utilization of specific templates, which are used to display personal information. Meta-data associated with personal information can be used to enhance the presentation of content. Templates can be specific to a file-type, so that photographs are displayed in a photo album format while Powerpoint documents are displayed in a presentation format.

The user interface 801 communicates with the content manager 804, administrator 803 and publisher 802 to implement the preferences defined by the user in the user interface.

The publisher 802 is used to serve all requested content. When the ShareFox Client 800 is turned on by the user, the publisher forms an outbound socket connection with the connection manager 811, part of the ShareFox Server 810. This outbound socket connection is maintained on an ongoing persistent basis between the publisher 802 and the connection manager 811, so there is always an open socket connection between the ShareFox Client 800 and the ShareFox Server 810. This connection is preferably a standard socket connection using standard TCP/IP protocols. The publisher 802 uses an outbound port that it detects is not otherwise in use and so is available for outbound connections. Those skilled in the art will appreciate that because the ShareFox Client 800 forms the outbound connection, the ShareFox Client 800 generally does not encounter any firewall or network connection issues that may typically preclude network communications between a desktop software application and other devices on the public Internet.

The publisher 802 maintains a persistent connection with the connection manager 811 and waits to receive communications from the connection manager 811. Based on these communications, the publisher 802 will receive a request from the connection manager for personal information. The publisher 802 authenticates this request and retrieves the content from the content manager 804 and returns this information to the connection manager 811.

The publisher 802 can return requested information to the connection manager 811 through the existing persistent socket connection. Alternatively, the publisher 802 creates a new outbound socket connection on a different port to the connection manager 811, and sends the requested information through this new socket connection. When the requested data transmittal is complete, the socket connection is closed. This method allows the publisher 802 to open multiple outbound socket connections and simultaneously return several different pieces of user content to the connection manager 811 if the connection manager 811 requests several different pieces of content at once.

The content manager 804 communicates with the publisher 802 and returns the content and other information requested by the publisher 802 so content can be served. This includes both original user content, as well as personal information that are transformed into formats applicable to specific usage applications. For example, photos are resized to be an appropriate size for viewing in a standard web browser environment, and HTML is generated so the photos can be viewed in a friendly photo-album format. Likewise, email messages stored in a Microsoft OUTLOOK email application as a PST file can be extracted and translated into text format so they can be remotely accessible.

The content manager 804 re transforms content on demand, and also transforms content into likely formats as personal information is created or updated by the user, so this information can be rapidly served in the appropriate environment on request. The content manager 804 also maintains a caching system to further speed responses to the publisher.

The administrator 803 communicates via HTTPS protocol to the ShareFox Server administration API 812. These communications are used for creating and updating usernames and passwords and similar administrative commands.

The administrator 803 communicates content permissions settings defined in the User Interface 801 to the ShareFox Server 810. These permissions are stored in the ShareFox's Server's permissions manager 814.

The ShareFox Server maintains a content cache 813, as further explained above. Administrative communications are used to synchronize content between the user's computer and the content cache 813 ensures a copy of frequently-accessed content is maintained in the content cache 813, and that the content cache 813 is not making available personal information that has been modified or deleted by the user.

When using this alternative embodiment of the hosted gateway configuration in accordance with an embodiment of the present invention, an individual may use a personal computer as a third-party computing device and a web browser. The individual may request a specific user photograph by entering the appropriate URL in the browser. In this example, the appropriate URL is the address of the ShareFox Server. The browser sends the request to the URL, which is received by the HTTP/HTTPS Server component of the ShareFox Server. The HTTP/HTTPS Server receives the request and transmits the request to the Permissions Manager.

Upon receipt of the request, the permissions manager authenticates the inbound request and determines whether the requesting individual has appropriate access rights to view the file. The permissions manager checks the content cache to determine if the content corresponding to the inbound request is locally cached on the ShareFox Server. If the content is not cached, the request is transmitted by the permissions manager to the connection manager.

The connection manager transmits the request to the ShareFox Client located on the appropriate user computer that contains the requested file. The request is transmitted through the persistent socket connection that was initiated by the publisher component and is connected to the connection canager.

The publisher receives the content request and forwards it to the content manager, which retrieves the requested file and resizes it if needed. The publisher receives the actual content to serve and creates a new outbound socket to the connection manager and transmits the requested content through this socket to the connection manager. When the transmission is complete, the publisher closes the content delivery socket.

As the connection manager receives the requested content, it forwards the received content to content transformation module if further content transformation is needed to deliver an appropriate response. In this case, no further content transformation is needed. So, as the connection manager receives the photograph, it forwards the data to the HTTP/HTTPS Server that originally received the inbound request.

As soon as the HTTP/HTTPS server starts to receive the response, it begins transmission of the response to the Internet browser that initiated the request. When the browser begins to receive the response to the request, the photograph begins to load into the browser, and the individual is able to view the requested viewer file.

When file transmission is complete, the connection manager takes a copy of the file and saves it into the content cache. When this image is requested in the future, it can then be directly requested from the cache. It is anticipated that the cache may be periodically emptied so as to manage the size of the cache. Alternatively the cache may be implemented with aging attributes for the data placed into the cache, whereby older data is gradually removed from the cache. For examples, the user may setup a default parameter that allows data to remain in the cache for a predetermined period of time before it is either used again or removed. Alternatively, different aging periods may be used for different types of data.

Sometime in the future, the user may decide to change the access rights of the picture. In the example set forth in FIG. 8, access rights may be changed by the user through the user interface 801, which are then automatically transmitted from the administrator 803 to the administration API handler 812 and then to the permissions manager 814.

The user may also decide to change the actual photograph with a standard photography editing program, such as the Adobe PHOTOSHOP application. In the example of FIG. 8, when the photo is changed and saved to the user's desktop file system, the content manager 804 detects this change and automatically makes copies of the file to sizes that are likely to be accessed in common requested environments. The administrator 803 then sends a message the administration API handler 812 that the photograph in question has been changed. The administration API handler 812 sends this information to the content cache 813, which in turn deletes the file from cache, so that the old version can no longer be accessed.

Collaborative Functionality

The systems and methods described herein can not only be used to remotely access user personal information, but also to modify files and personal information stored on the user's computer and to remotely save new files and information to the user's personal computer.

For example, the third-party computing device 820 can transmit requests to add a new file or personal information to the user machine, or to modify an existing file. These requests, along with the new and/or modified file or piece of content, is transmitted through a web browser 821, email client 822 or standard communications software (such as a cell phone's SMS client 823) in a manner similar to requests for content residing in the user computer.

When the ShareFox Server 810 receives the submitted file and request, it is transmitted to the permissions manager 814, which authenticates the request. If the request is permissible, the submitted file and request is transmitted to the connection manger 811.

The connection manager 811 transmits a notification to the ShareFox Client publisher 802 that a request to add or modify user content has been received. The publisher 802 sends this information to the administrator 803. At the same time, the connection manager 811 transmits the file to the administration API handler 812. The administrator 803 performs and HTTP request to the administration API handler 812 to receive the file or user content, and the information is transmitted. After information receipt, the administrator 803 saves the information in the user file system.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for installing a personal server application on a user's personal computer, comprising:
initiating an installation procedure for the personal server application;
determining if the user's personal computer communication status is compatible with one of a plurality of personal server application modes;
completing the installation of the personal server application;
receiving a viewer's request for personal digital information maintained on the user's personal computer; and
providing the requested personal digital information without the need to upload the set of personal digital information to another server.

2. The method of claim 1, wherein the completing step further comprises:
analyzing a network connection associated with the user's personal computer; and
configuring the personal server application to receive the viewer's request.

3. The method of claim 1, wherein the providing step further comprises
providing the requested personal digital information in an alternative format optimized for the viewer.

4. A system for remotely accessing personal digital information that resides on a user computer, comprising:
a communication interface for receiving a viewer's request for the personal digital information maintained on the user computer;
a permission manager module operatively coupled to the communication interface, the permission manager module being capable of authenticating the viewer's request;
a connection manager module operatively coupled to the communication interface and the permission manager module, the connection manager module maintaining a connection to the user computer and receiving the personal digital information from the user computer via the connection in response to a client request associated with the viewer's request; and
wherein the connection manager module provides the personal digital information in a predetermined format to the communication interface.

5. The system of claim 4, further comprising a content transformation module operatively connected to the connection manager module and for altering the personal digital information from an initial format into the predetermined format prior to sending the personal digital information in the predetermined format to the communication interface.

6. The system of claim 5, further comprising a content cache for storing the personal digital information in the predetermined format for use with a subsequent viewer request for the personal digital information.

7. The system of claim 4, wherein the communication interface is selected from the group consisting of a web server interface, an electronic mail interface, an FTP interface, and an SMS gateway interface.

8. The system of claim 4, wherein the connection is a persistent socket connection between the user's computer and system.

9. The system of claim 4, wherein the communications interface utilizes at least one protocol from the group consisting of HTTP, HTTPS, FTP, TCP/IP and UDP.

10. The system of claim 4, wherein the connection manager module is further operative to receive new personal digital information from the communication interface and provide the new personal digital information for storage on the user computer via the connection.

11. The system of claim 4, wherein the connection manager module is further operative to receive a modification for the personal digital information stored on the user computer and provide the modification to the user computer via the connection.

12. A method for remotely accessing personal digital information that resides on a user computer, comprising the steps of:
forming a socket connection between the users computer and a server computer;
receiving a viewer request for the personal digital information from a third party computing device;
initiating a request for the personal digital information using the socket connection;
receiving the personal digital information from the users computer; and
providing the personal digital information in a predetermined format to the third party computing device.

13. The method of claim 12, wherein the receiving step further comprises receiving the personal digital information using the socket connection.

14. The method of claim 12, wherein the receiving step further comprises receiving the personal digital information by using an additional socket connection from the user computer to the server computer.

15. The method of claim 12, wherein the receiving step further comprises receiving the personal digital information in an initial format and transforming the personal digital information from the initial format to the predetermined format before the providing step.

16. The method of claim 12 further comprising the step of saving the personal digital information provided to the third party computing device in a content cache for use with a subsequent request for the same personal digital information.

17. The method of claim 16 further comprising the step of updating the version of the personal digital information saved within the content cache with updated personal digital information.

18. The method of claim 17, wherein the step of updating further comprises updating the version of the personal digital information saved within the content cache with updated personal digital information provided by the third party computing device.

19. A computer-program product having instructions for remotely accessing personal digital information that resides on a user computer, which when executed, perform steps comprising:
forming a persistent socket connection between the users computer and a server computer, where the socket connection is initiated by a computer-program product residing on the user computer;
receiving a request for the personal digital information from a third party computing device, the request having an HTTP, HTTPS, FTP or email protocol;
retrieving the personal digital information from a storage on the users computer; and
providing the personal digital information in a desired format to the third party computing device through the requested protocol.

20. The computer-program product of claim 19, wherein the providing step further comprises communicating the personal digital information to the third party computing device in a dynamically selected format based upon attributes of the request.
